(19) United States
(12) Patent Application Publication
(10) Pub. No.: US 2025/0139540 A1
(43) Pub. Date: May 1, 2025

(54) INFORMATION PROCESSING APPARATUS, MUTUAL WATCHING METHOD, RECORDING MEDIUM, AND MUTUAL WATCHING SYSTEM

(71) Applicant: NEC Corporation, Minato-ku (JP)

(72) Inventor: Junichi SHIMOMURA, Tokyo (JP)

(73) Assignee: NEC Corporation, Minato-ku (JP)

(21) Appl. No.: 18/923,812

(22) Filed: Oct. 23, 2024

(30) Foreign Application Priority Data
Oct. 31, 2023 (JP) 2023-186739

(51) Int. Cl. G06Q 10/0631

(52) U.S. Cl. CPC G06Q 10/0631

(57) ABSTRACT

Provided are an information processing apparatus, etc. capable of promoting mutual assistance among the members of a group (optimizing the manner of mutual assistance). The information processing apparatus includes: a member evaluating section for performing, based on a status of provision of care provided to a member who is inferred to be in a state of being in need of care from among members of a group and provided by one or more other members of the group, evaluations of degrees of contribution of the one or more other members to the group; and an evaluation result presenting section for presenting results of the evaluations to the members of the group. With this information processing apparatus, it is also possible to support decision-making performed by the members of a group.

### CROSS REFERENCE TO RELATED APPLICATIONS

This application is based upon and claims the benefit of priority from Japanese Patent Application No. 2023-186739 filed on Oct. 31, 2023, the disclosure of which is incorporated herein in its entirety by reference.

### TECHNICAL FIELD

The present disclosure relates to an information processing apparatus, a mutual watching method, a recording medium, and a mutual watching system.

### BACKGROUND ART

By analyzing the facial image of a person, it is possible to infer various states regarding the person. For example, Patent Literature 1 below discloses a patient surveillance apparatus that uses the facial image of a medical examinee to infer the feelings of the medical examinee and calculates, on the basis of the feeling inference result and consultation information of the examinee, a stress value indicating the degree of stress the medical examinee feels.

### CITATION LIST

### Patent Literature

### [Patent Literature 1]

Japanese Patent Application Publication Tokukai No. 2020-146345

### SUMMARY OF INVENTION

### Technical Problem

In the patient surveillance apparatus disclosed in Patent Literature 1, the division of roles is fixed such that a medical examinee (patient) being on the part of a person under surveillance and the staff or the like of a medical facility is on the part of a person conducting surveillance. In this respect, in some cases, the form of not fixing the division of roles in mutual assistance is considered to be preferable to fixing the division of roles such that someone of a group members is on the part of a watcher and someone else is on the part of a person watched over. For example, in a case where one of the members of a group becomes mentally or physically ill, it can be preferable that among the members of the group, not a predetermined member but a member who can provide care for the ill member at the moment provides care.

However, in a case where the respective roles of the members are not fixed, smooth mutual assistance might not be achieved unless a technique for promoting mutual assistance among the members is applied. For example, in a case where the respective roles of the members are not fixed, the burden of care could concentrate on a specific member. In addition, not fixing the roles could lead to a reliance on other members, and willing care is therefore less likely to be provided. In order not to fall into such a situation, a technique for promoting mutual assistance among members is required. However, there has not been such a technique before.

The present disclosure has been made in view of the above problems, and an example object thereof is to provide, for example, an information processing apparatus capable of promoting mutual assistance among the members of a group.

### Solution to Problem

An information processing apparatus in accordance with an example aspect of the present disclosure includes at least one processor, and the at least one processor carries out: a member evaluating process of performing, based on a status of provision of care provided to a member who is inferred to be in a state of being in need of care from among members of a group and provided by one or more other members of the group, evaluations of degrees of contribution of the one or more other members to the group; and an evaluation result presenting process of presenting results of the evaluations to the members of the group.

A mutual watching method in accordance with an example aspect of the present disclosure includes: at least one processor performing, based on a status of provision of care provided to a member who is inferred to be in a state of being in need of care from among members of a group and provided by one or more other members of the group, evaluations of degrees of contribution of the one or more other members to the group; and the at least one processor presenting results of the evaluations to the members of the group.

A recording medium in accordance with an example aspect of the present disclosure is a computer-readable non-transitory recording medium having recorded thereon a control program for causing a computer to carry out: a member evaluating process of performing, based on a status of provision of care provided to a member who is inferred to be in a state of being in need of care from among members of a group and provided by one or more other members of the group, evaluations of degrees of contribution of the one or more other members to the group; and an evaluation result presenting process of presenting results of the evaluations to the members of the group.

### Advantageous Effects of Invention

An example aspect of the present disclosure provides an example advantage of making it possible to provide a technique for promoting mutual assistance among the members of a group.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of a mutual watching method in accordance with the present disclosure.

FIG. 3 is a representation of an example configuration of the mutual watching system in accordance with the present disclosure.

FIG. 4 is a block diagram illustrating a configuration of another information processing apparatus in accordance with the present disclosure.

FIG. 5 is a representation of example management information.

FIG. 6 is a block diagram illustrating an example configuration of a terminal in accordance with the present disclosure.

FIG. 7 is a representation of example UI screens displayed before and after notification of a member in need of care.

FIG. 8 is a representation of example UI screens displayed during presentation of a report, presentation of data, and a video call.

FIG. 9 is a representation of example UI screens on which to present the evaluation results of members and a group.

FIG. 10 is a representation of an example UI screen on which to display an evaluation result ranking.

FIG. 11 is a flowchart illustrating example processes carried out by the information processing apparatus illustrated in FIG. 4.

FIG. 12 is a flowchart illustrating example processes carried out by the terminal illustrated in FIG. 6.

FIG. 13 is a block diagram illustrating a configuration of a computer which functions as the information processing apparatuses in accordance with the present disclosure.

### EXAMPLE EMBODIMENTS

The following description will discuss example embodiments of the present invention. However, the present invention is not limited to the example embodiments described below, but can be altered by a skilled person in the art within the scope of the claims. For example, any embodiment derived by appropriately combining technical means adopted in differing example embodiments described below can be within the scope of the present invention. Further, any embodiment derived by appropriately omitting one or more of the technical means adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide the example embodiments advantages mentioned in the example described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### [Configuration of Information Processing Apparatus 1]

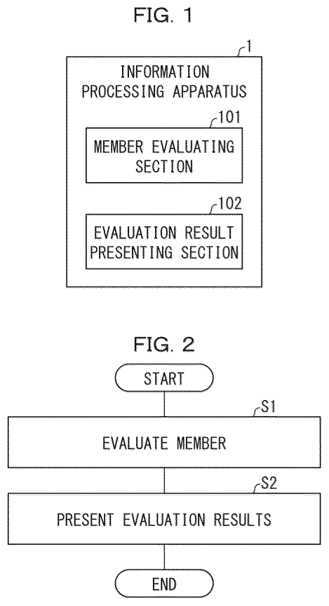

The configuration of an information processing apparatus 1 will be described below with reference to FIG. 1. FIG. 1 is a block diagram illustrating the configuration of the information processing apparatus 1. The information processing apparatus 1 includes a member evaluating section 101 and an evaluation result presenting section 102, as illustrated in FIG. 1.

The member evaluating section 101 performs, based on the status of provision of care provided to a member who is inferred to be in a state of being in need of care from among members of a group and provided by one or more other members of the group, evaluations of degrees of contribution of the one or more other members to the group.

As used herein, the term “care” refers to actions in general which are performed in order to maintain or improve the state of a member. Examples of the “care” includes talking, by phone, to a member who is physically ill to check the state of the member, saying something and sending a message to a member who is feeling depressed or mentally unstable. The term “care” is interchangeable with consideration, attention, or help.

The state of a member in which the member is in need of the “care” may be determined in advance. For example, members such as a member with a high stress level inferred from an image and a member with a tendency toward a rise in stress level inferred from an image may be taken as the member in need of the “care”. In this case, the member evaluating section 101 performs the evaluations based on the status of provision, by the one or more other members, of care (an action promising for the effect of reducing a stress level) for a member with a high stress level. The evaluation based on the status of provision of care may be performed by an evaluation method in which the status of provision of care is reflected in an evaluation result. Further, in this evaluation, a factor other than the status of provision of care may be considered. For example, in addition to the status of provision of care provided by each member, the member evaluating section 101 may take an action for strengthening the trust relationship (interchangeable with the degree of trust) among the members of a group and an action for strengthening bonds or ties among the members of a group as actions for increasing the “degree of contribution to a group”, to evaluate these actions. Note that the stress level is an index value indicating the level of stress.

The “degree of contribution to a group” means the degree of contribution to the establishment of a mutual assistance relationship in a group, the maintenance of the mutual assistance relationship, or the promotion of the mutual assistance relationship. The “degree of contribution to a group” is interchangeable with engagement with a group, the degree of well-being of a group, the soundness of a group, or the like. It can be said that the action of providing care for a member inferred to be in a state of being in need of care in a group is the action for increasing the engagement (degree of contribution) with the group. Thus, the member evaluating section 101 can evaluate the engagement (degree of contribution) based on the status of provision of care. Note that the “engagement” means a “deep mutual commitment or relationship”. An evaluation of the engagement can be performed based on an evaluation item such as, for example, the degree of contribution to a group such as a company, the trust relationship (degree of trust) built between a company and a client, family bonds, or a common goal.

The evaluation result presenting section 102 presents the results of the evaluations performed by the member evaluating section 101, to the members of a group. The members who become subject to the presentation may be the members subjected to the evaluations, or may be other members. Further, the members who become subject to the presentation may be all the members of a group, or may be some of the members of a group. The manner of the presentation is not particularly limited. As an example, the evaluation result presenting section 102 may cause terminals used by the respective members of a group to output the results of the evaluations. As another example, the evaluation result presenting section 102 may cause any output equipment, such as displaying equipment (e.g. a television) or audio output equipment (e.g. a speaker), shared by the respective members to output the results of the evaluations.

As above, the information processing apparatus 1 includes: a member evaluating section 101 for performing, based on the status of provision of care provided to a member who is inferred to be in a state of being in need of care from among members of a group and provided by one or more other members of the group, evaluations of degrees of contribution of the one or more other members to the group; and an evaluation result presenting section 102 for presenting results of the evaluations to the members of the group.

With this configuration, the degree of contribution of a members to a group is evaluated on the basis of the status of provision of care provided to a member who is in a state of being in need of care and provided by one or more other members, and the results of the evaluation is presented. This evaluation result can be a motivation for promoting mutual assistance among the members of the group. Thus, this configuration provides an example advantage of making it possible to promote mutual assistance among the members of a group.

For example, with this configuration, it is possible to provide the motivation for the members who have received low evaluations in the degree of contribution to increase the degrees of contribution. With this configuration, it is also possible to make the members who have received high evaluations in the degree of contribution feel satisfied and also provide the motivation for such members to continue the contribution. Further, the presentation of the results of the evaluations acts as a trigger for expressing gratitude to the members of high degrees of contribution. Such communication can contribute to the promotion of mutual assistance among the members. Furthermore, with the information processing apparatus 1, it is possible to support decision-making performed by the members of a group.

### [Configuration of Control Program]

The functions of the information processing apparatus 1 can also be implemented via a program. A control program in accordance with the present example embodiment causes a computer to function as: a member evaluating means for performing, based on the status of provision of care provided to a member who is inferred to be in a state of being in need of care from among members of a group and provided by one or more other members of the group, evaluations of degrees of contribution of the one or more other members to the group; and an evaluation result presenting means for presenting the results of the evaluations to the members of the group. Thus, the control program in accordance with the present example embodiment provides an example advantage of making it possible to promote mutual assistance among the members of a group. Alternatively, the information processing apparatus 1 makes it possible to optimize the manner of mutual assistance among the members of a group.

### [Flow of Mutual Watching Method]

A flow of a mutual watching method will be described below with reference to FIG. 2. FIG. 2 is a flowchart illustrating a flow of the mutual watching method. It should be noted that each of the steps of this mutual watching method may be carried out by a processor included in the information processing apparatus 1, or may be carried out by a processor included in another apparatus. Alternatively, the respective steps may be carried out by processors provided in different apparatuses.

In S1 (member evaluating process), at least one processor performs, based on the status of provision of care provided to a member who is inferred to be in a state of being in need of care from among members of a group and provided by one or more other members of the group, evaluations of degrees of contribution of the one or more other members to the group.

In S2 (evaluation result presenting process), the at least one processor presents the results of the evaluations performed in S1, to the members of the group. Note that the process of S2 does not need to necessarily be carried out immediately after S1. For example, the process of S2 may be carried out upon acceptance of the operation for presenting the evaluation results, after the process of S1 is carried out.

As above, the mutual watching method includes: a member evaluating process of at least one processor performing, based on the status of provision of care provided to a member who is inferred to be in a state of being in need of care from among members of a group and provided by one or more other members of the group, evaluations of degrees of contribution of the one or more other members to the group; and an evaluation result presenting process of the at least one processor presenting results of the evaluations to the members of the group. Thus, the mutual watching method provides an example advantage of making it possible to promote mutual assistance among the members of a group.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of each of the technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings referred to for the description of the present example embodiment can be adopted in another example embodiment included in the present disclosure, to the extent of constituting no specific technical obstacle.

### (Configuration of Mutual Watching System 3)

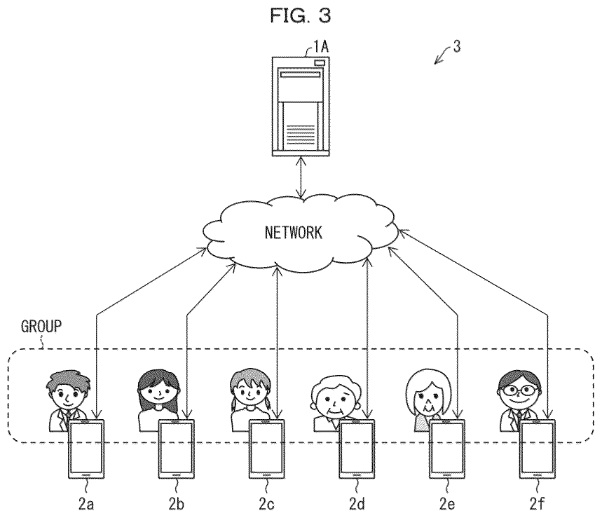

FIG. 3 is a representation of an example configuration of a mutual watching system 3. The mutual watching system 3 includes an information processing apparatus 1A and terminals 2a to 2f, as illustrated. The mutual watching system 3 supports mutual watching performed among the members of a group. For example, as illustrated, in a case where the respective users of the terminals 2a to 2f constitute a group, the information processing apparatus 1A supports mutual watching performed among these users. In the following description, the terminals 2a to 2f are denoted simply as “terminals 2” in a case where it is not necessary to distinguish therebetween. Although six terminals 2 are illustrated in FIG. 3, the mutual watching system 3 only needs to include at least two terminals 2.

The information processing apparatus 1A supports mutual watching performed among the members of a group. Like the information processing apparatus 1 above, the information processing apparatus 1A performs, based on the status of provision of care provided to a member who is inferred to be in a state of being in need of care from among members of a group and provided by one or more other members of the group, evaluations of degrees of contribution of the one or more other members to the group. The information processing apparatus 1A then presents the results of the evaluations to the members of the group. The presentation of the evaluation results is performed via, for example, the terminals 2.

The terminals 2 are used by the users of the mutual watching system 3, so that the users use the mutual watching system 3. For example, each of the terminals 2 displays evaluation results notified by the information processing apparatus 1A, to present the evaluation results to the user (i.e. one of the members of the group) of the terminal 2. The terminals 2 may produce audio output of the evaluation results notified by the information processing apparatus 1A, to present the results to the members. Illustrated in FIG. 3 is the example in which the terminals 2 are smartphones. However, the terminals 2 only need to be equipment that implements the functions such as accepting a user's input, transmitting the accepted input to the information processing apparatus 1A, and presenting various kinds of information notified by the information processing apparatus 1A, and are not limited to smartphones. Further, the terminals 2 may each be portable equipment, or may each be stationary equipment.

As above, the mutual watching system 3 includes: an information processing apparatus 1A that performs, based on the status of provision of care provided to a member who is inferred to be in a state of being in need of care from among members of a group and provided by one or more other members of the group, evaluations of degrees of contribution of the one or more other members to the group; and terminals 2 that present the results of the evaluations performed by the information processing apparatus 1A, to the members who uses the terminals 2. This provides an example advantage of making it possible to promote mutual assistance among the members of a group.

In the mutual watching system 3, the members of a group are not assigned fixed roles. This makes it easy to maintain mutual assistance relationship even if the number of members increases or decreases. Any members can constitute a group. For example, it is possible for the mutual watching system 3 to support mutual assistance among the members of a group constituted on a family-unit basis or a group constituted by various members of workers of the same work place, a sports team, various clubs, etc.

### [Configuration of Information Processing Apparatus 1A]

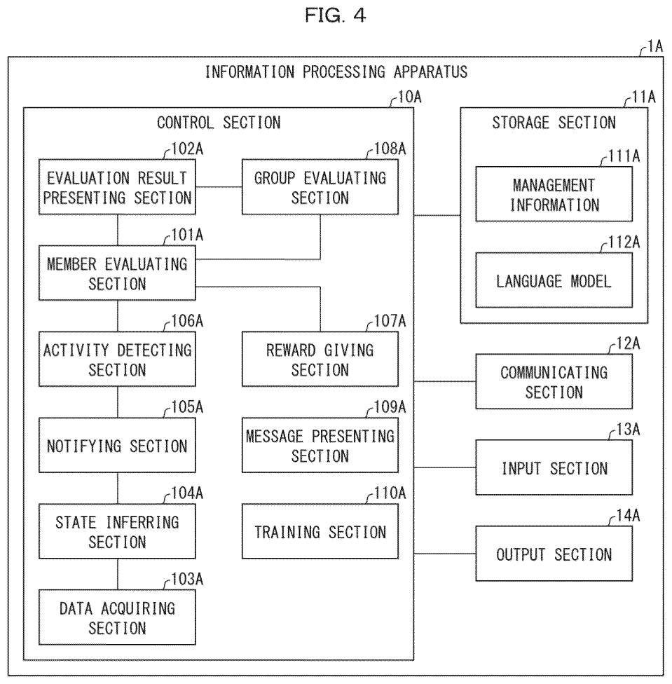

The configuration of the information processing apparatus 1A will be described below on the basis of FIG. 4. FIG. 4 is a block diagram illustrating an example configuration of the information processing apparatus 1A. As illustrated, the information processing apparatus 1A includes: a control section 10A for performing overall control of the sections of the generation apparatus 1A; and a storage section 11A in which various kinds of data used by the generation apparatus 1A are stored. The information processing apparatus 1A further includes: a communicating section 12A through which the information processing apparatus 1A communicates with another apparatus; an input section 13A for accepting the input, to the information processing apparatus 1A, of various kinds of data; and an output section 14A through which the information processing apparatus 1A outputs various kinds of data.

The control section 10A includes a member evaluating section 101A, an evaluation result presenting section 102A, a data acquiring section 103A, a state inferring section 104A, a notifying section 105A, an activity detecting section 106A, a reward giving section 107A, a group evaluating section 108A, a message presenting section 109A, and a training section 110A. The storage section 11A has stored therein management information 111A and a language model 112A. The reward giving section 107A, the group evaluating section 108A, and the training section 110A will be described later in the sections “Reward giving”, “Evaluation method (evaluation of group”), and “Training”, respectively. The management information 111A will be described later in the section “Management information”.

Like the member evaluating section 101 of the first example embodiment, the member evaluating section 101A performs, based on the status of provision of care provided to a member who is inferred to be in a state of being in need of care from among members of a group and provided by one or more other members of the group, evaluations of degrees of contribution of the one or more other members to the group. A method for the evaluation performed by the member evaluating section 101A will be described later in the section “Evaluation method”.

Like the evaluation result presenting section 102 of the first example embodiment, the evaluation result presenting section 102A presents the results of the evaluations of the members performed by the member evaluating section 101A, to the members of the group. A method for presenting the evaluation results only needs to make the members who are subject to the presentation aware of the evaluation results. As an example, the evaluation result presenting section 102A may present the evaluation results by causing the terminals 2 of the members to produce display output or audio output of the evaluation results. As another example, the evaluation result presenting section 102A may present the evaluation results by causing the output section 14A to output the evaluation results.

The data acquiring section 103A acquires information required for inferring the state of a member. For example, the data acquiring section 103A may acquire an image of a member as information for inferring the state of the member. For example, the data acquiring section 103A may acquire an image which is captured during a video call made by the member with use of the terminal 2 or the like and which is used for the video call.

The state inferring section 104A infers the state of a member. Various methods can be used as the method for inferring the state. For example, the state inferring section 104A may use an image acquired by the data acquiring section 103A, to infer the state of a member shown in the image. The state to be inferred only needs to be a state which is capable of being inferred from an image and which serves as information for judging whether care provided by one or more other members is necessary. For example, the state inferring section 104A may infer at least one selected from the group consisting of stress level, degree of concentration, cognitive function, feelings, degree of arousal, and degree of tension. Further, in inferring these states, the state inferring section 104A may detect at least one selected from the group consisting of facial color change, facial movement, gaze, blink, pupil diameter, iris movement, and facial expression. As a method for inferring these states from an image, well-known methods can be used.

The state inferring section 104A may further judge, based on the result of the above inference, disease or the presence or absence of a sign of the disease. For example, the state inferring section 104A may judge whether a member is showing a sign of at least one selected from the group consisting of dementia, mental disease, hypertension, heart disease, diabetes, and cancer. In a case of the judgment of disease, it is preferable to notify not only the members of a group but also medical personnel, such as a doctor.

The state inferring section 104A may use information other than an image, to infer the state of a member. For example, in a case where the member uses a wearable device, the state inferring section 104A may acquire various kinds of vital data and/or data on the amount of activity or the like that are measured by the wearable device, to use the data for the state inference. Further, the state inferring section 104A may infer the state in consideration of the history of disease, chronic disease, checkup result, etc. of the member.

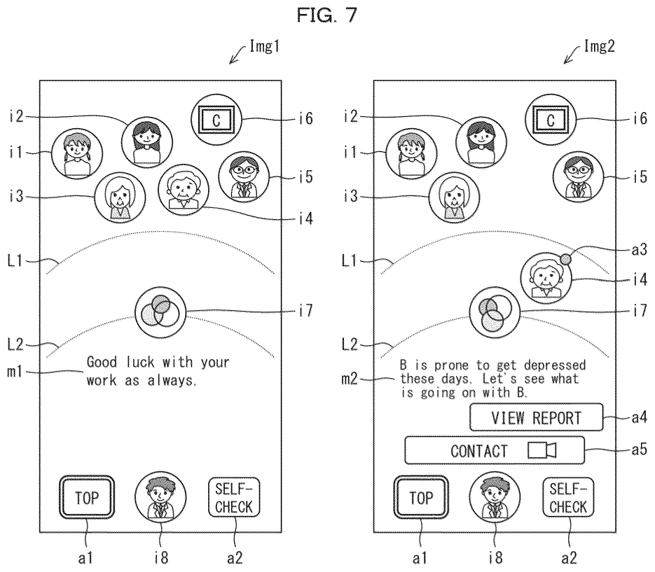

The notifying section 105A provides notification of a member of a group inferred, by the state inferring section 104A, to be in a state of being in need of care, to other members of the group. The members who are the notification receivers may be all or some of the members except the member inferred to be in need of care. Further, what state is the state of a member in need of care may be determined in advance. Furthermore, the state of a member in which the member is in need of care may be settable for each of the members. For example, in a case where a member with hypertension is included in a group, what is inferred by the state inferring section 104A for the member and the state of the member in which the member is in need of care may be set respectively to blood pressure and the blood pressure going out of the normal range. This makes it possible to, upon the inferred value of the blood pressure of the member going out of the normal range, notify other members of the blood pressure of the member going out of the normal range, to urge the other members to provide care. Notification provided by the notifying section 105A will be described later on the basis of FIG. 7, etc. In a case where even if a predetermined amount of time passes after each of the members is notified of a member in need of care, it cannot be confirmed that care has been provided, the notifying section 105A may provide reminder notification to each of the members.

The activity detecting section 106A detects a predetermined activity of each of the members in the mutual watching system 3. The results of the activity detection are recorded in the management information 111A, and used for evaluations performed by the member evaluating section 101A. What to take as the predetermined activity may be determined in advance. As an example, the activity detecting section 106A may detect, as the predetermined activity, having provided care for another member, having communicated with another member, etc. As another example, the activity detecting section 106A may detect, as the predetermined activity, having checked the state of another member, having performed self-check (described later), etc.

A method for activity detection may be determined as appropriate according to the activity of a detection target, and is not particularly limited. For example, in a case where notification to the effect that care has been provided is received from a member who provided the care or a member who received the care, the activity detecting section 106A may detect the provision of care. As still another example, the activity detecting section 106A may detect, as the predetermined activity in the mutual watching system 3, the sending of a message and a call that are conducted with use of a messaging feature and a video call feature in the mutual watching system 3.

The message presenting section 109A presents a message generated with use of the language model 112A, to the members. Specifically, the message presenting section 109A presents a message to the members by, for example, inputting a query to the language model 112A to cause the language model 112A to generate the message and displaying the generated message on the terminals 2. The message presenting section 109A may present the generated message as a message from, for example, a virtually existing assistant (hereinafter referred to as a virtual assistant) who interacts with the members who use the mutual watching system 3.

The language model 112A is a type of generative artificial intelligence (AI), and is a model having learned, by machine learning, the arrangement of the components (such as words) of a sentence and the arrangement of sentences in text. By using the language model 112A, the message presenting section 109A can generate a message to be presented to a member and generate an answer to a question inputted by a member.

In the mutual watching system 3, registering a business operator as a member of a group may be allowed. As used herein, the “business operator” covers individuals and corporates in general which do business. For example, by registering, as a member of a group, a temporary care worker employment agency, a hospital, a doctor, a health professional, or an insurance company, it is possible to provide watching among members which include these business operators or employees of the business operators.

As above, the information processing apparatus 1A includes: a member evaluating section 101A for performing, based on the status of provision of care provided to a member who is inferred to be in a state of being in need of care from among members of a group and provided by one or more other members of the group, evaluations of degrees of contribution of the one or more other members to the group; and an evaluation result presenting section 102A for presenting results of the evaluations to the members of the group. This provides an example advantage of making it possible to promote mutual assistance among the members of a group.

The information processing apparatus 1A further includes: a state inferring section 104A for inferring the state of a member from an image of the member; and a notifying section 105A for providing notification of a member of a group inferred, by the state inferring section 104A, to be in a state of being in need of care, to other members of the group. This makes it possible to easily detect, with use of an image, a member who has fallen into a state of being in need of care and urge the other members to provide care by making the other members aware of the presence of the member. That is, in addition to the example advantage provided by the information processing apparatus 1, an example advantage of making it possible to further promote mutual assistance in a group is obtained.

### [Management Information]

The management information 111A is information for managing the groups which use the mutual watching system 3 and the members belonging to each of the groups. For example, the management information 111A contains the details of an activity detected by the activity detecting section 106A, the result of an evaluation performed by the member evaluating section 101A, etc.

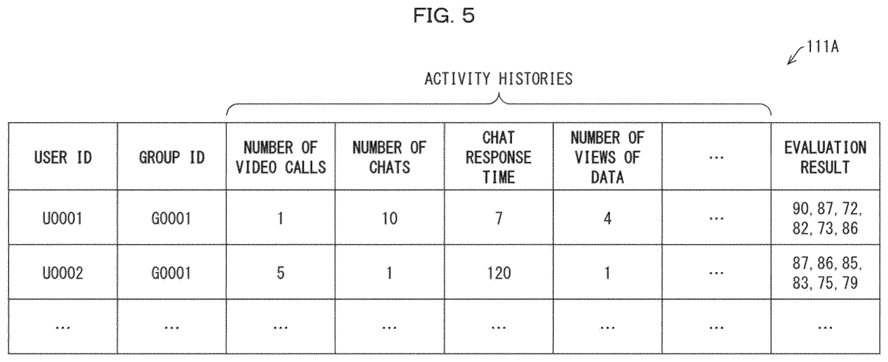

FIG. 5 is a representation of an example of the management information 111A. The management information 111A illustrated contains items of a “user ID” and a “group ID”. The “user ID” is the identification assigned to a user of the mutual watching system 3. The “group ID” is the identification assigned to a group registered with the mutual watching system 3. In the illustrated example, both of the group IDs associated with the user of the user ID “U0001” and the user of the user ID “U0002” are “G0001”. This indicates that these users are members of the group of the group ID “G0001”.

The management information 111A illustrated also contains activity histories including the “number of video calls”. These activity histories indicate the results of the detections performed by the activity detecting section 106A. The “number of video calls” indicates the number of video calls made among the members of a group in a predetermined period of time with use of the video call feature of the mutual watching system 3. The “predetermined period of time” is a target period in which to perform the member evaluations. This period may be determined as appropriate. Further, the “number of video calls” recorded as the activity history may be the number of video calls made in response to the notification of a member in need of care and made by originating a call for the member. It can be said that the “number of video calls” in this case is the number of times one or more other members have provided care.

The “number of chats” indicates the total number of times messages are sent and received among the members of a group in a predetermined period of time with use of the messaging feature of the mutual watching system 3. Like the number of video calls, the “number of chats” recorded as the activity history may be the number of times messages are sent to a member in need of care in response to notification of the member.

The “chat response time” indicates the average of response times (the times from reception of a message to sending of a reply) in sending and receiving messages among the members of a group in a predetermined period of time with use of the messaging feature of the mutual watching system 3. It can be said that the shorter the “chat response”, the higher the degree of interest in another member. Thus, the “chat response time” can be used for the evaluation of a member.

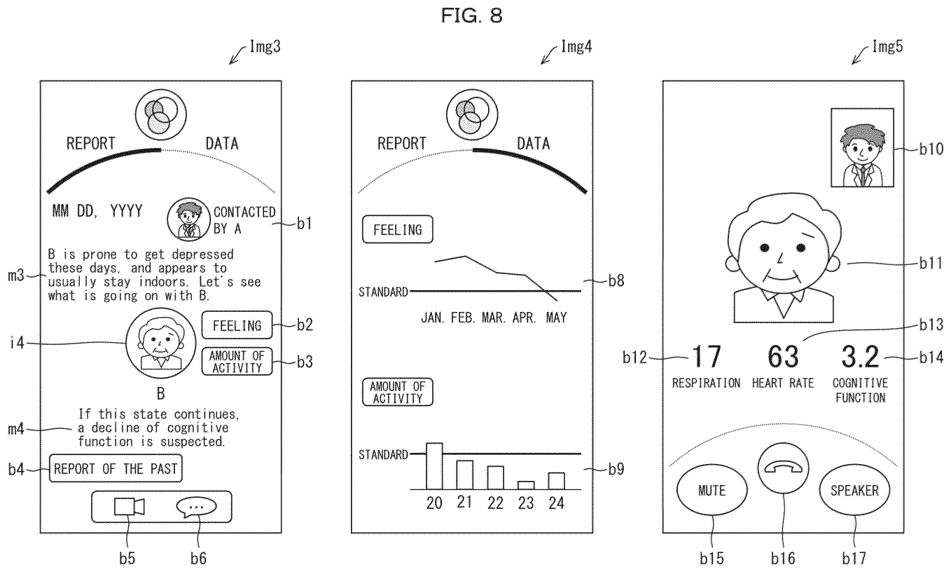

The “number of views of data” indicates the number of views of data which indicates the result of inference of the state of a member, the inference being performed by the mutual watching system 3. It can be said that the greater the “number of views of data”, the higher the degree of interest in another member. Thus, the “number of views of data” can be used for the evaluation of a member. For example, the number of views of the “report” or the “data” illustrated in FIG. 8 (described later) may be the “number of views of data”.

The management information 111A illustrated further contains the item “evaluation result”. The “evaluation result” indicates the result of an evaluation performed by the member evaluating section 101A. In the example of FIG. 5, six numerical values are recorded as the “evaluation result”. The respective numerical values indicates the evaluation results of six evaluation items. The evaluation items will be described later in the section “Evaluation method”. Note that the “evaluation result” indicates the result of an evaluation performed with use of the above activity histories. Accordingly, upon update to the activity histories, the member evaluating section 101A updates the “evaluation result” with use of the updated activity histories.

### [Evaluation Method (Evaluation of Member)]

A method whereby the member evaluating section 101A evaluates a member will be described below. As described above, the member evaluating section 101A performs, based on the status of provision of care provided to a member who is inferred to be in a state of being in need of care from among members of a group and provided by one or more other members of the group, evaluations of degrees of contribution of the one or more other members to the group.

As described above, the information processing apparatus 1A includes the state inferring section 104A and the notifying section 105A. Thus, the member evaluating section 101A may perform the evaluations on the basis of at least one selected from the group consisting of, for example, the number of responses to the notification provided by the notifying section 105A, a response-to-notification ratio (the ratio of the number of responses to the number of notifications), the details of a response to notification (making a video call, visiting a member personally, etc.), and the speed of response to notification (the time from notification to response).

The member evaluating section 101A may perform the evaluations in consideration of a perspective other than the status of provision of care. For example, the member evaluating section 101A may perform the evaluations on the basis of the number, the frequency, the details, etc. of communications conducted by a member with another member, regardless of whether the other ends of the communications is in a state of being in need of care. Further, to maintain mutual assistance in a group, it is important for each member to be careful about their own health states. The member evaluating section 101A may therefore perform the evaluations on the basis of the status of health management of each member and/or the status of an activity carried out for their health.

Described in the following is the example in which for each of the members, the member evaluating section 101A calculates an evaluation value of each of six evaluation items which are “ties among members”, “thoughtfulness”, “physical and mental health”, “positive feelings”, “common activity”, and the “degree of achievement of goal”.

A method for calculating the evaluation value may be determined in advance. For example, in a case of “ties among members”, by modeling the relationship between the history of an activity considered to contribute to deepening the ties among members and an evaluation value in accordance with this history, it is possible to calculate an evaluation value in accordance with the activity history of each member. As a specific example of this, for each of the number of video calls made among members, the number of chats, and the number of views of data, a score in accordance with that number may be determined. In this case, the member evaluating section 101A may take the sum of the scores as the evaluation value of the “ties among members”.

Further, for example, in a case of “thoughtfulness”, a model which renders, as scores, the number of responses to notification provided by the notifying section 105A, the speed of a response to the notification, and the like may be prepared. This applies to “positive feelings” and a “common activity”, and it is thus possible for the member evaluating section 101A to use a model which renders, as scores, activities related to these evaluation items, to calculate the evaluation values of these evaluation items. Furthermore, for example, in a case of “physical and mental health”, a model which renders, as scores, the number of self-checks, the result of self-check, the result of health checkup or cognitive function test, the amount of activity, etc. may be prepared.

Further, the member evaluating section 101A may calculate the “degree of achievement of goal” based on a goal (which may be set by a member) set in advance and an index based on which the degree of achievement of the goal is evaluated. Assume, for example, that a goal of making not less than 10 video calls with a member of a group in a month is set. In this case, where the evaluation value of not less than 10 video calls made in a month is 100 (maximum value), for less than 10 video calls, the member evaluating section 101A may take a value calculated by the formula of 100×(the number of video calls in a month)/10 as the evaluation value.

Any method is used as the method of the evaluation, and in addition, any manner is used as the manner of expressing the evaluation result. For example, the evaluation result may be expressed not by numerical values but by which of predetermined categories such as “good”, “average”, and “in need of improvement” the evaluation result falls under.

The member evaluating section 101A may take into consideration the relationship between an activity of a member carried out in a group and a change in the state of another member after the activity, to evaluate the member who carried out the activity. This makes it possible to evaluate high an activity which probably has improved the state of another member, and thereby provide the motivation for each member to carry out such an activity.

In this case, the member evaluating section 101A extracts an activity which probably has caused a change in the state of another member, from activities on which to perform the evaluations, and evaluate a member who carried out the activity. Note that the member evaluating section 101A may evaluate only a member whose activity is extracted. Further, the member evaluating section 101A may perform the evaluation such that the degree of contribution of the extracted activity to the evaluation result is evaluated higher than that of an activity which is not extracted. For example, the member evaluating section 101A may give a predetermined score to a member who made a video call with a member in need of care, in response to the notifying section 105A providing notification of the member in need of care, and give an additional score if the inference result of the state of the member in need of care improves after the video call.

### [Evaluation Method (Evaluation of Group)]

A method whereby the group evaluating section 108A evaluates a group will be described below. On the basis of the results of the evaluations of the members of a group performed by the member evaluating section 101A, the group evaluating section 108A evaluates the group. The information processing apparatus 1A, which includes the group evaluating section 108A, provides an example advantage of making it possible to provide the motivation for the members of a group to carry out an activity which contributes to the group, in addition to the example advantage provided by the information processing apparatus 1.

A method for evaluating a group is not particularly limited. For example, in a case where the results of the evaluations of the members of a group are represented by numerical values, i.e. evaluation values, the group evaluating section 108A may take the average of or the sum of the evaluation values of the members as the result of the evaluation of the group. Further, the group evaluating section 108A may calculate the evaluation value of a group for each of the evaluation items including, for example, the above “ties among members”, and then combine the calculated evaluation values together to calculate an overall evaluation value. For example, the group evaluating section 108A may calculate the average of the evaluation values of the respective members for each of the evaluation items, and take this average as the result of the evaluation of the group for that evaluation item. Furthermore, the group evaluating section 108A may calculate the sum of the evaluation values of the respective evaluation items, and take this sum as the overall evaluation value.

As another example, the group evaluating section 108A may use an index value which indicates the equality among the degrees of contribution of the respective members, to perform the evaluation of the group. This provides an example advantage of making it possible to provide the motivation for the members of a group to make the degrees of contribution of the members equal to each other, in addition to the example advantage provided by the information processing apparatus 1. For example, the group evaluating section 108A may perform the evaluation such that the higher the equality among the degrees of contribution of the members of a group is, the more the evaluation result improves, or the lower the equality among the degrees of contribution of the members of a group is, the more the evaluation result decreases.

As described above, the degrees of contribution of the members of a group can be represented as evaluation values. The group evaluating section 108A may therefore use, as the above-described index value, an index value which indicates the equality among the evaluation values of the members. For example, as the index value which indicates the equality, at least one selected from the group consisting of a deviation, a variance, standard deviation, and the difference between a maximum value and a minimum value can be used.

A method for reflecting the calculated index value in the evaluation result may be determined as appropriate. For example, in a case where the difference between the maximum value and the minimum value of the evaluation values of the members of a group is equal to or greater than a predetermined threshold, the group evaluating section 108A may reduce the evaluation value of the group at a predetermined rate. Alternatively, in the above case, the group evaluating section 108A may subtract a predetermined value from the evaluation value of the group.

In a case where the equality among the degrees of contribution of the members of a group is low (e.g. a case where the above index value is equal to or smaller than a predetermined threshold or equal to or greater than a predetermined threshold), the notifying section 105A may provide notification to that effect to a member of the group. The notification receiver may be all of the members, may be a member of a high degree of contribution, or may be a member of a low degree of contribution. This makes it possible to make the members which are the notification receivers aware of the situation where the burden of care is concentrated on some of the members, and thereby encourage the elimination of such a situation.

### [Reward Giving]

The reward giving section 107A gives a reward in accordance with the result of an evaluation performed by the member evaluating section 101A, to a member subjected to the evaluation performed by the member evaluating section 101A. This provides an example advantage of making it possible to provide the motivation for each member to improve their evaluation results, in addition to the example advantage provided by the information processing apparatus 1. What reward is given and for what evaluation result the reward is given may be determined in advance.

The “reward” is given in exchange for an activity of a member carried out in the mutual watching system 3, and is interchangeable with a “benefit” or the like. For example, the reward giving section 107A may give, as the reward, points for using various services associated with the mutual watching system 3. In this case, the reward giving section 107A may give greater points as the evaluation is higher. Note that any reward is given, and a merchandise, a cash voucher, or the like may be given as the reward.

The reward giving section 107A may give the reward for each of the activities of a member based on which the evaluation is performed. As an example, the reward giving section 107A may give the reward for carrying out a video call with a member in need of care, to a member who made the video call. As another example, the reward giving section 107A may give the reward to a member who provided care a large number of times or a member who provided care at a high frequency, or may give the rewards to a predetermined number of members ranked high in the group on the evaluation. As still another example, the reward giving section 107A may give the reward for achievement of a predetermined goal if a member achieves the goal. In this manner, also by giving the reward for each of the activities of a member based on which the evaluation is performed, it is possible to give the reward in accordance with the results of the evaluations performed by the member evaluating section 101A.

The reward giving section 107A may give the reward to a group. For example, the reward giving section 107A may give the rewards to a predetermined number of groups ranked high on the result of an evaluation performed by the group evaluating section 108A, from among a plurality of groups subjected to the evaluation. This provides an example advantage of making it possible to provide the motivation for the members of each group to increase the evaluation of their group, in addition to the example advantage provided by the information processing apparatus 1.

For example, the reward giving section 107A may give predetermined rewards to top three groups, or top ten groups. Further, the reward giving section 107A may make the rewards to be given different according to the ranking. Furthermore, the reward giving section 107A may give the reward for a group to the representative member of the group or to each member of the group. Note that the giving of the reward to an individual member and the giving of the reward to a group may be carried out by respective processing blocks.

### [Training]

The training section 110A retrains the language model 112A. More specifically, the training section 110A retrains the language model 112A with use of a message (hereinafter referred to as an effective message) from among messages presented by the message presenting section 109A, the message resulting in, after the messages are presented to the members, an improvement in the results of the evaluations of the members performed by the member evaluating section 101A.

In extracting the effective message, the training section 110A may read the results of evaluations of a member from the management information 111A, the evaluations being performed in a plurality of respective evaluation target periods, to identify a period for which the evaluation result is improved compared with that for the immediately preceding period, or a period for which the evaluation result is good. The training section 110A may then acquire, as the effective message, the message presented by the message presenting section 109A in the identified period. Note that a message having been presented is stored in the storage section 11A, etc. so as to be associated with the members to which the message was presented, the date and time of the presentation, a query inputted to the language model 112A at the time of the generation of the message, etc.

The training section 110A then retrain the language model 112A with use of labeled training data in which the query inputted to the language model 112A at the time of the generation of an effective message is associated, as ground-truth data, with the effective message. This makes it possible to make a message likely to be generated, the message being similar to an effective message and leading to an improvement in the evaluation result of a member.

As above, the information processing apparatus 1A includes: a message presenting section 109A for presenting a message generated with use of the language model 112A trained by machine learning, to the members; and a training section 110A for retraining the language model 112A with use of a message from among messages presented by the message presenting section 109A, the message resulting in, after the message is presented to the members, an improvement in the results of the evaluations of the members performed by the member evaluating section 101A. This provides an example advantage of making it possible to update the language model 112A such that a message leading to an improvement in the evaluation result is likely to be presented, in addition to the example advantage provided by the information processing apparatus 1.

### [Configuration of Terminals 2]

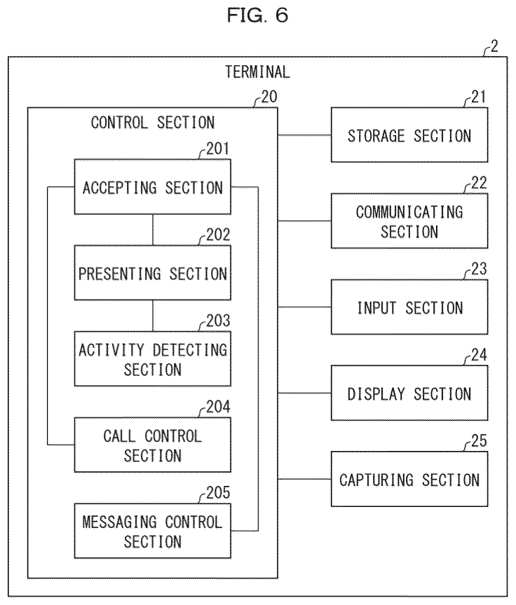

The configuration of the terminals 2 will be described below on the basis of FIG. 6. FIG. 6 is a block diagram illustrating an example configuration of the terminals 2. As illustrated, the terminals 2 each include: a control section 20 for performing overall control of the sections of the terminal 2; and a storage section 21 in which various kinds of data used by the terminal 2 are stored. Further, the terminals 2 each include: a communicating section 22 via which the terminal 2 communicates with another apparatus; an input section 23 for accepting the input, to the terminal 2, of various kinds of data; a display section 24 for displaying an image; and a capturing section 25 for capturing an image (still image or moving image). Further, the control section 20 includes an accepting section 201, a presenting section 202, an activity detecting section 203, a call control section 204, and a messaging control section 205. For example, by installing on a general-purpose computer a control program for causing a computer to function as each of these sections, it is possible to cause the computer to function as the terminal 2.

The accepting section 201 accepts various inputs regarding the mutual watching system 3. As an example, the accepting section 201 accepts an input from a member who is using the terminal 2, to notify the information processing apparatus 1A of the content of the input. As another example, the accepting section 201 accepts various notifications (e.g., notification of a member in need of care) from the information processing apparatus 1A.

The presenting section 202 presents various kinds of information regarding the mutual watching system 3. For example, in a case where the accepting section 201 accepts notification of a member in need of care, the presenting section 202 may light an indicator (not illustrated) of the terminal 2 or cause an audio output section (not illustrated) to output a notification sound, to notify the member who is using their own terminal 2 of reception of the notification.

The presenting section 202 displays various UI screens on the display section 24, to present various kinds of information regarding the mutual watching system 3, to a member who is using the terminal 2. The UI screens may be generated by the information processing apparatus 1 and then acquired and displayed by the presenting section 202, or may be generated by the presenting section 202. The UI screens will be described later on the basis of FIGS. 7 to 10.

The activity detecting section 203 detects a predetermined activity in the mutual watching system 3, the predetermined activity being carried out by a member who uses the terminal 2. The result of the activity detection is notified to the information processing apparatus 1A, recorded in the management information 111A, and used for an evaluation performed by the member evaluating section 101A. What to take as the predetermined activity may be determined in advance. As an example, the activity detecting section 203 may detect, as the predetermined activity, a call between members made via the call control section 204 (described later) or the sending and receiving of messages between members carried out via the messaging section 205 (described later). As another example, in a case where the accepting section 201 accepts an input operation which indicates that care for a member has been provided, the activity detecting section 203 may detect provision, by a member who uses the terminal 2, of care.

The call control section 204 performs control for making a video call among members. More specifically, the call control section 204 originates a video call to a member according to the input accepted by the accepting section 201. Further, the call control section 204 carries out the process of terminating a video call and the process of switching the input and output of voice to a speaker mode (hands-free call mode), according to the input accepted by the accepting section 201. The call control section 204 can cause a voice-only call, in which no video is displayed, to be made.

The messaging control section 205 performs control for exchanging messages among members. More specifically, the messaging control section 205 carries out processes such as the process of displaying, on a timeline, messages transmitted and received among the members in the past, the process of accepting the input of a new message, and the process of adding an inputted message to a timeline. Note that the messages are not limited to those to be displayed on a timeline. For example, the messaging control section 205 may notifies each individual member of a message for the member.

### [Example User Interface (UI) Screens: Notification of Member in Need of Care]

Example UI screens displayed on the terminals 2 in the mutual watching system 3 will be described below on the basis of FIG. 7. FIG. 7 is a representation of example UI screens displayed before and after the notification of a member in need of care. Specifically, in FIG. 7, an Img 1 is an example UI screen on which notification of a member in need of care is not being provided, and an Img 2 is an example UI screen on which notification of a member in need of care is being provided.

A member who uses the mutual watching system 3 performs a login to the mutual watching system 3 by, for example, inputting the identification (ID) of the member into the terminal 2. The presenting section 202 identifies the member on the basis of the ID, and displays on the display section 24 a UI screen for the member. The Img 1 and the Img 2 are examples of the UI screen, displayed in such a manner, for an individual member. The process of generating the Img 1 and the Img 2 may be carried out by the information processing apparatus 1A, or may be carried out by the terminal 2. In the following description, a member who browses the UI screen after performing the login as described above is referred to as a browsing member.

In the Img 1, eight icons which are i1 to i8 are displayed. Among these icons, i8 is the icon of the browsing member. Further, i7 is the icon indicating the virtual assistant described above. Furthermore, i2 to i6 are the icons of the respective members who belong to the same group as the browsing member. More specifically, among the icons i2 to i6, the icons i2 to i5 indicate persons each registered as the member, and the icon i6 indicates a business operator registered as the member. For each of the icons i2 to i5 and i8, the image of the corresponding member is displayed, whereas for the icon i6, a mark indicating a business operator is displayed. In this manner, the presenting section 202 of the terminal 2 may display the icon of a business operator and the icon of a person in an identifiable manner.

In the Img 1, the icons i2 to i6 of the members are displayed in an at-a-glance manner above a line L1. The icon i8 of the browsing member and a message m1 are displayed below a line L2. The message m1 is a message generated with use of the language model 112A and meant for a browsing member, and is displayed as a message from the virtual assistant.

In the Img 1, the icon i7 is disposed between the icon i1 and the icons i2 to i6. This makes it possible to make the browsing member aware that the virtual assistant represented by the icon i7 is an intermediate between the browsing member and the members of the group which are represented by the icons i2 to i6.

In the Img 1, a button a1 for displaying a top screen and a button a2 for initiating a self-check are also displayed. Note that the top screen is a screen of the Img 1 in which the icons of the respective members are displayed in an at-a-glance manner.

The self-check means that the browsing member causes the information processing apparatus 1A to judge their own state. Upon acceptance of an operation performed on the button a2, the accepting section 201 activates the capturing section 25 to capture an image of a member, and transmits the captured image to the information processing apparatus 1A. Upon reception of the image, in the information processing apparatus 1A, the data acquiring section 103A acquires the image, and the state inferring section 104A analyzes the image to infer the state of the browsing member. The terminal 2 is notified of the result of the inference, and the presenting section 202 of the terminal 2 presents the notified result of the inference to the browsing member, by, for example, displaying the notified result on the display section 24.

In the Img 2 illustrated in FIG. 7, among the icons i2 to i6 of the members, the display position of the icon i4 is changed to the area between the lines L1 and L2. The icon i4 represents the member who is inferred, by the state inferring section 104A of the information processing apparatus 1A, to be in a state of being in need of care. Such a change in the display position is performed on the basis of the notification from the notifying section 105A.

In this manner, the presenting section 202 may present a member in need of care to the browsing member, on the basis of the notification from the notifying section 105A, by changing the display position of the icon i4 of the member in need of care from the original display position, which is the area above the line L1, to a position located within a predetermined display area sandwiched between the lines L1 and L2. This makes it possible to make the browsing member intuitively aware that the member of the icon i4 is in need of care.

A badge a3 is displayed so as to be associated with the icon i4. This makes it possible to make the browsing member aware that there is information that should be checked out regarding the member in need of care corresponding to the icon a4. For example, the presenting section 202 may end the display of the badge a3 in response to the browsing member having checked out a report on the state of the member in need of care.

In the Img 2, a message m2 describing the state of the member in need of care (named B) is further displayed. The message m2 may be generated by putting the name of the member in need of care into a state-specific template prepared in advance, or the message presenting section 109A may generate the message m2 with use of the language model 112A.

In the Img 2, a button a4 for displaying a report on the analysis of the state of the member in need of care is also displayed. In a case where the browsing member performs an input operation on the button a4, the presenting section 202 displays the report on the display section 24. The details of the report will be described later on the basis of FIG. 8.

In the Img 2, a button a5 for making a video call with the member in need of care is also displayed. In a case where the browsing member performs an input operation on the button a5, the call control section 204 originates a call for making a video call with the member in need of care. This enables the browsing member to smoothly start a video call with the member in need of care.

As above, from among icons which correspond to the respective members of the group and which are displayed on a display screen that the members are allowed to browse, the notifying section 105A may change the display position of the icon of the member in need of care to a position within a predetermined display area set on the display screen. This provides an example advantage of making it possible to make each member of a group easily aware of the emergence of a member who becomes the member in need of care among the members, in addition to the example advantage provided by the information processing apparatus 1. Thus, it is possible to support decision-making regarding early handling of the member in need of care.

Any area can be the determined display area. For example, the predetermined display area may be set between the area in which to display the icons of the members and the area in which to display the icon of the browsing member, as in the example UI screens illustrated in FIG. 7. This makes it possible to make the browsing member feel as if a member in need of care asks the browsing member for care, and thereby urge the browsing member to provide care.

The notifying section 105A may generate a UI screen having the display position of the icon of the member in need of care changed thereon and transmit the generated UI screen to the terminal 2, to cause the terminal 2 to display the UI screen. Further, the UI screen may be generated by the presenting section 202 of the terminal 2. In this case, from among the icons which correspond to the respective members of a group and which are displayed on a display screen that the members are allowed to browse, the presenting section 202 changes the display position of the icon of the member in need of care to a position within the predetermined display area set on the display screen, according to the notification from the notifying section 105A.

In a case where the activity detecting section 106A detects the provision, by a member of the group, of care for the member in need of care, the notifying section 105A ends the notification regarding the target member. For example, in a case where provision of care for the member in need of care is detected while the UI screen is displayed, the notifying section 105A may generate a new UI screen and transmit the generated UI screen to the terminal 2, to cause the UI screen to be updated. In this respect, the new UI screen is the UI screen having the display position of the icon of the member in need of care returned to the display area in which to display the icons of the respective members (the area above the line L1 in the example of FIG. 7).

As to the members for which the UI screen is not displayed at the time of detection of the provision of care for the member in need of care, the notifying section 105A causes a UI screen to be displayed for such members, the UI screen having the display position of the icon of the member in need of care returned to the display area in which to display the icons of the respective members of the group, at the next UI screen display timing or any subsequent UI screen display timing. The update and/or generation of such a UI screen may be carried out by the presenting section 202 of the terminal 2.

### [Example UI Screens: Report⋅Data⋅Video Call]

FIG. 8 is a representation of example UI screens displayed during presentation of a report, presentation of data, and a video call. Specifically, in FIG. 8, an Img 3 is an example UI screen on which to present a report, an Img 4 is an example UI screen on which to present data which supports the report, and an Img 5 is an example UI screen displayed during a video call.

The Img 3 indicates a report on the state of the member in need of care named B. In the Img 3, not only the icon i4 of B is displayed, but a message m3 describing the state of B, a message m4 describing matters to be attended to regarding the state of B, and objects b2 and b3 representing pieces of data which support the detection of B as the member in need of care are also displayed. The messages m3 and m4 may be in fixed forms which are in accordance with the state of the member in need of care, or the message presenting section 109A may generate the messages m3 and m4 with use of the language model 112A.

In the Img 3, also displayed are: the date of preparation of the report; information b1 indicating a member who has contacted B; a button b4 for displaying a report of the past; a button b5 for making a video call with B; and a button b6 for sending a message to B.

In a case where the button b4 is operated, the presenting section 202 displays a report of the past. In a case where the button b5 is operated, the call control section 204 originates a call for making a video call with the member in need of care. In a case where the button b6 is operated, the messaging control section 205 accepts input of a message meant for the member in need of care by, for example, displaying an input acceptance screen on which a message meant for the member in need of care is accepted.

The Img 4 illustrates an example UI screen for presenting data which supports the report of the Img 3. Specifically, displayed in the Img 4 are: a graph representing a change over time in “feeling” indicated in the object b2 of the Img 3; and a graph representing a change over time in the “amount of activity” indicated in the object b3 of the Img 3. The “feeling” and the “amount of activity” are inferred by the state inferring section 104A. By storing, in the storage section 11A or the like, the results of inference carried out by the state inferring section 104A, the notifying section 105A can use the stored results of inference to generate a UI screen which contains such graphs. Optionally, the notifying section 105A may notify the terminal 2 of the results of inference, and the presenting section 202 of the terminal 2 may generate, on the basis of the notified results of inference, a UI screen which contains the graphs.

The Img 5 illustrates an example UI screen during a video call. In the Img 5, displayed are: an image b10 of the browsing member; an image b11 of the other end (the member in need of care in this example) of the call; pieces of information b12 to b14 which indicate the results of state inference carried out by the state inferring section 104A; a mute button b15 for muting utterance given by the browsing member; a call end button b16 for ending a video call; and a switch button b17 for switching audio input-output to a speaker mode.

The data acquiring section 103A may acquire time series images (which may be a moving image) captured during a video call and used for the video call. The state inferring section 104A may then infer the state of a member from each of the acquired images (or each of the frame images extracted from a moving image). This enables the notifying section 105A to update, in real time, the pieces of information b12 to b14 displayed on the UI screen.

As above, the state inferring section 104A may infer the state of a member from images captured during a video call made by the member and used for the video call. This eliminates the need to cause the member to capture images for the state inference. Further, for example, simply by making regular video calls among the members, it is possible to record changes in the state.

As described above, the state inferring section 104A may repeatedly carry out state inference during a video call, to generate a time-series state inference result. In this case, the notifying section 105A may use a representative value of the time-series inference result provided by the state inferring section 104A, to judge whether the member is right for the member in need of care. Examples of the representative value include a mean, a maximum, a minimum, a median, and a mode.

The state inference results or the like are private information regarding the members. As such, the members may each set their respective scopes of disclosure and their respective pieces of information subject to disclosure. In this case, the notifying section 105A or the presenting section 202 provides notification or presentation of the state inference results or the like within the set scope.

### [Example UI Screens: Presentation of Evaluation Result]

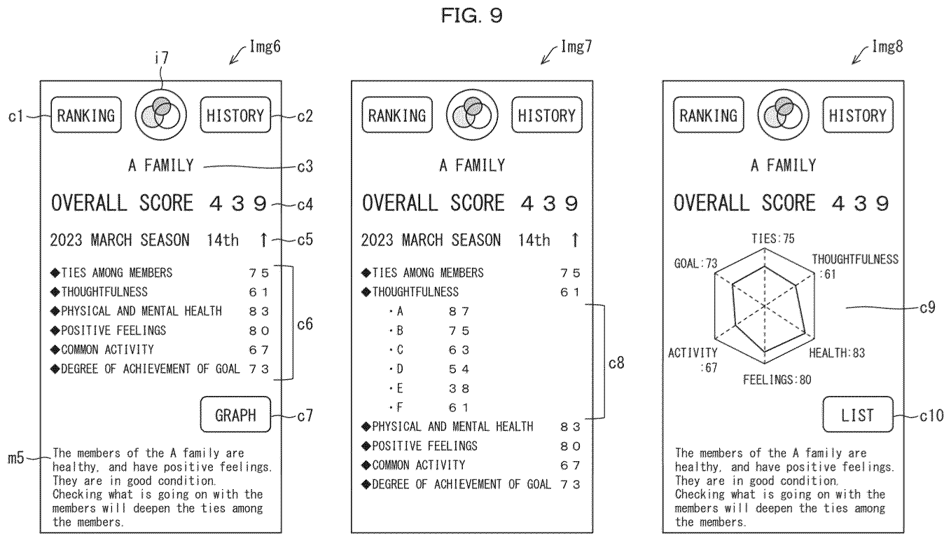

FIG. 9 is a representation of example UI screens on which to present the evaluation results of members and a group. An Img 6 illustrated in FIG. 9 is displayed on the display section 24 of the terminal 2, in response to, for example, performance of the operation, on the terminal 2, of displaying evaluation results.

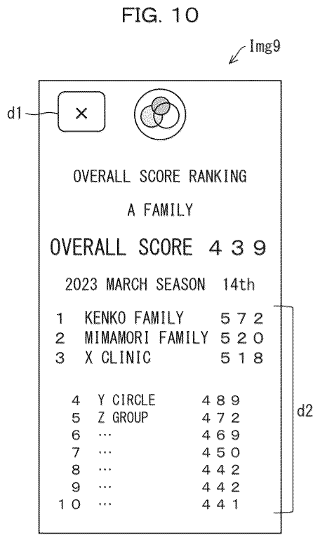

In the Img 6, a button c1 for displaying an evaluation result ranking, the icon i7 indicating the virtual assistant, and a button c2 for displaying the history of evaluation results are displayed. Upon operation on the button c1, an evaluation result ranking is displayed. Upon operation on the button c2, evaluation results of the past are displayed. The evaluation result ranking will be described later on the basis of FIG. 10.

Further, in the Img 6, the group name of a group which is subjected to the evaluation is displayed in c3, the evaluation result is displayed in c4, and the target period in which the evaluation was performed and the ranking of the group are displayed in c5. The up arrow displayed on the right side of the ranking indicates that the ranking is higher than that for the immediately preceding target period. The group name may be registered by the members of the group in advance. In the example of FIG. 9, the group name is the “A Family”. Further, the evaluation result of the group, i.e. the “A Family”, in the example of FIG. 9 is represented by a numerical value referred to as an “overall score”.

In c6 of the Img 6, the evaluation results of the respective evaluation items of the “A Family” are displayed. Specifically, displayed in c6 are the respective evaluation values of six evaluation items which are “ties among members”, “thoughtfulness”, “physical and mental health”, “positive feelings”, “common activity”, and the “degree of achievement of goal”. The above overall score is calculated with use of these evaluation values.

The evaluation value of each of the evaluation items is calculated from the evaluation values of that evaluation item of the respective members. The evaluation values of the respective members may be displayed upon, for example, selection of an evaluation item. An Img 7 illustrated in FIG. 9 is an example UI screen displayed in response to selection of the “thoughtfulness”, which is one of the evaluation items displayed in the Img 6. Displayed in c8 of the Img 7 are the evaluation values of the evaluation item “thoughtfulness” of the respective members (named A to F) of the “A Family”. The evaluation value (60 points) for “thoughtfulness” of the “A Family” is calculated with use of the evaluation values (the scores from 87 points for A to 61 points for F), displayed in c8, of “thoughtfulness” of the respective members.

In Img 6, a button a7 for displaying a graph which indicates evaluation results and a message m5 regarding the evaluation results are also displayed. The message m5 may be in a fixed form which is in accordance with the value of the overall score, or the message presenting section 109A may generate the message m5 with use of the language model 112A.

Upon operation of the button a7, a graph in which the evaluation values, displayed in c6, of the respective evaluation items are rendered is displayed. An Img 8 illustrated in FIG. 9 is an example UI screen in which the evaluation values of the respective evaluation items are rendered in a graph. In c9 of the Img 8, a radar chart which indicates the respective evaluation values of six evaluation items is displayed. The radar chart has the advantage in that the balance between the evaluation values is easily understood. The form of the graph is not particularly limited. Also displayed in the Img 8 is a button c10 for restoring the display form of the evaluation values to a list display. Operation on the button c10 leads to return to the UI screen of the Img 6.

As described above, upon operation on the button c1 of the Img 6, an evaluation result ranking is displayed. FIG. 10 is a representation of an example UI screen on which to display an evaluation result ranking. In an Img 9, a button d1 for ending the display of a ranking is displayed, and in addition, the group names of top 10 groups and the overall scores of the groups are displayed in d2 of the Img 9. With this display, which allows a comparison among the evaluation results of respective groups, it is possible to provide the motivation for the members of each group to increase the evaluation of their group.

### [Flow of Processes: Information Processing Apparatus 1A]

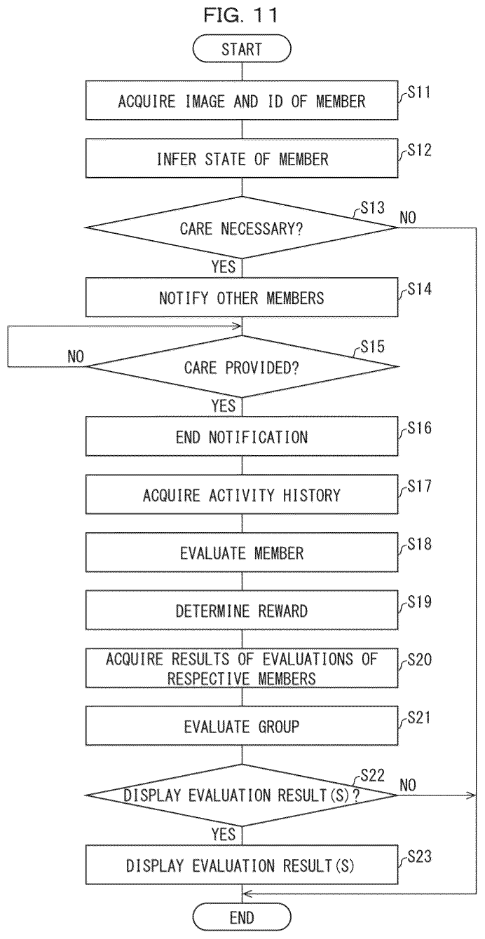

A flow of processes carried out by the information processing apparatus 1A will be described below on the basis of FIG. 11. FIG. 11 is a flowchart illustrating a flow of processes carried out by the information processing apparatus 1A. The flow of FIG. 11 includes the mutual watching method in accordance with the present example embodiment.

In S11, the data acquiring section 103A acquires the image of a member. For example, the data acquiring section 103A may acquire an image captured by the terminal 2 during a video call made by the member, or may acquire an image captured by the terminal 2 during a self-check performed by the member. Further, the data acquiring section 103A acquires the ID of the member, in addition to the image of the member. The data acquiring section 103A may also acquire data useable in inferring the state of the member, such as vital data of the member.

In S12, the state inferring section 104A uses the image acquired in S11, to infer the state of the member shown in the image. Note that in a case where data other than the image is acquired in S11, the state inferring section 104A also uses the data to infer the state of the member. In addition, the state inferring section 104A may infer the state of the member without using an image. In this case, in S11, the data acquiring section 103A acquires data other than an image as date to be used in inferring the state of the member.

In S13, based on the result of the inference carried out in S12, the notifying section 105A judges whether care for the member subjected to state inference is necessary. As described above, based on which state of a member it is judged that care is necessary is determined in advance. In a case of No judgment in S13, the processing of FIG. 11 ends. In a case of YES judgment in S13, the processing continues to S14.

In S14, the notifying section 105A provides notification of a member judged in S13 to be in need of care, to the other members. The notification may contain the ID of the member in need of care. The members who are notification receivers may be all or some of the members of the same group in which the member judged to be in need of care is included. For example, the notifying section 105A provides notification of the ID of the member in need of care, to the terminals 2 of the respective members who are the notification receivers.

In S15, the activity detecting section 106A judges whether care for the member in need of care has been provided by a member of the group. In a case of NO judgment in S15, the process of S15 is carried out again after the elapse of a predetermined amount of time. Note that in a case where the number of repetitions of the process of S15 reaches a predetermined upper limit, the processing of FIG. 11 may be ended, or the notifying section 105A may provide notification again. In a case of YES judgment in S15, the activity detecting section 106A adds the details of the activity performed, i.e. the details of the care for the member, to the activity history of the member who provided the care. Thereafter, the processing continues to S16. Note that the activity history is recorded on the management information 111A.

In S16, the notifying section 105A ends notification regarding a member judged in S13 to be in need of care. For example, in a case where a UI screen such as the Img 2 of FIG. 7 generated by the notifying section 105A is displayed, the notifying section 105A performs an update to change this UI screen to a UI screen such as the Img 1. In a case where such a UI screen is generated by the presenting section 202 of the terminal 2, the notifying section 105A transmits the ID of the member in need of care to the terminal 2, and instructs that the display position of the icon of a member identified by the ID be changed.

In S17, the member evaluating section 101A acquires the activity history of the member who provided care for the member judged in S13 to be in need of care. As described above, the activity history is recorded on the management information 111A. Note that in S17, in a case where besides the activity added to the activity history in response to the YES judgment in S15, there is any history of activities on which to perform the evaluations, the member evaluating section 101A also acquire the history.

In S18 (member evaluating process), the member evaluating section 101A uses the activity history acquired in S17, to evaluate the degree of contribution of the member who provided the care to the group. That is, in S18, based on the status of provision of care provided to a member who is inferred to be in a state of being in need of care from among members of a group and provided by one or more other members of the group, evaluations of degrees of contribution of the one or more other members to the group are performed.

In S19, the reward giving section 107A determines a reward which is to be given to a member subjected to the evaluation in S18 and which is in accordance with the result of the evaluation. In addition, the reward giving section 107A may give the determined reward in S19. Further, the reward giving section 107A may give the reward on condition that a predetermined condition is met. For example, the reward giving section 107A may give the reward on condition that the result of the evaluation performed in S18 is equal to or greater than a predetermined threshold. The timing at which the reward is given is not limited to the example of FIG. 11. For example, after the period of the compilation of the evaluation expires, the reward giving section 107A may give the reward which is in accordance with the evaluation result for the entire period of the compilation.

In S20, the group evaluating section 108A acquires the evaluation results of the respective members of the same group in which the member subjected to the evaluation in S18 is included. For example, by recording the evaluation results on the management information 111A, it is possible for the group evaluating section 108A to refer to the management information 111A to acquire the evaluation results.

In S21, based on the evaluation results acquired in S20, the group evaluating section 108A evaluates the group to which the member subjected to the evaluation in S18 belongs.

In S22, the evaluation result presenting section 102A judges whether to display the evaluation result. For example, in a case where the operation for displaying the evaluation result is performed on the terminal 2 used by a member, the evaluation result presenting section 102A may judge that the evaluation result should be displayed. In a case of No judgment in S22, the processing of FIG. 11 ends. In a case of YES judgment in S22, the processing continues to S23.

In S23 (evaluation result presenting process), the evaluation result presenting section 102A displays on the terminal 2 at least one selected from the group consisting of the result of the evaluation performed in S18 and the result of the evaluation performed in S21. For example, the evaluation result presenting section 102A may display the UI screen such as the Img 6 of FIG. 9, to present the result of the evaluation performed in S21. Thereafter, in response to performance of the operation of displaying the evaluation result of the member, the evaluation result presenting section 102A may display the UI screen such as the Img 7 of FIG. 9, to present the result of the evaluation performed in S18.

The evaluation results are presented in any presentation manner and at any location. For example, the evaluation result presenting section 102A may present the evaluation results by causing the terminal 2 to produce audio output of the evaluation results, by causing displaying equipment other than the terminal 2 to display the evaluation results, or by causing audio output equipment other than the terminal 2 to produce audio output of the evaluation results. With the end of the process of S23, the processing of FIG. 11 ends.

### [Flow of Processes: Terminal 2]

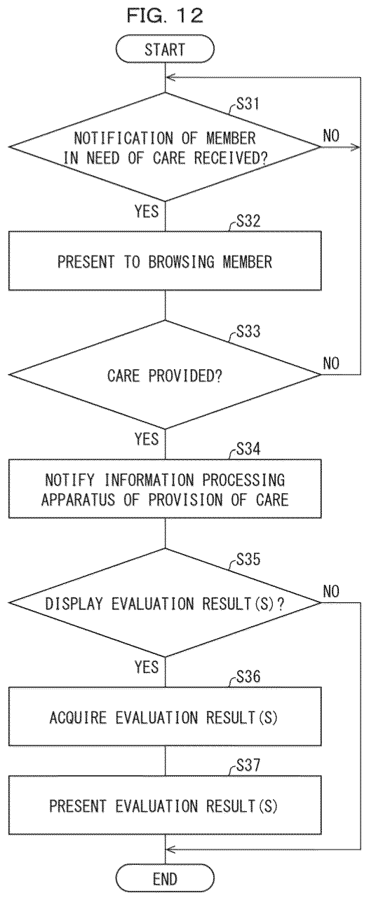

A flow of processes carried out by the terminal 2 will be described below on the basis of FIG. 12. FIG. 12 is a flowchart illustrating a flow of processes carried out by the terminal 2.

In S31, the accepting section 201 judges whether notification indicating the emergence of a member in need of care is received. This notification is transmitted from the information processing apparatus 1A in S14 of FIG. 11. In a case of YES judgment in S31, the processing continues to S32, and in a case of NO judgment in S31, the judgment of S31 is carried out again after the elapse of a predetermined amount of time.

In S32, on the basis of the notification received in S31, the presenting section 202 presents the member in need of care to the member who uses the terminal 2. The presentation is performed in any manner. For example, in a case where the member who is using the terminal 2 is browsing the UI screen of the mutual watching system 3 (i.e. in a case where this member is the browsing member), the presenting section 202 may present the member in need of care by changing the display position of the icon of the member in need of care (see the Img 2 of FIG. 7).

In a case where the above notification is received in a situation where the UI screen is not displayed, the presenting section 202 may first urge the member to check the UI screen, and present the member in need of care by displaying a UI screen such as the Img 2 in response to the operation of displaying the UI screen. A method for urging the member to check the UI screen is not particularly limited. For example, the presenting section 202 may urge the member to check the UI screen by causing the terminal 2 to produce at least one selected from the group consisting of light, sound, and vibration, or by displaying a message or an object on the display section 24.

In S33, the activity detecting section 203 judges whether care has been provided by the browsing member, who is browsing the above UI screen. For example, in a case where a UI screen such as the Img 2 of FIG. 7 is presented to the browsing member, and the operation of selecting the button a5 is performed, a video call between the browsing member and the member in need of care is made via the call control section 204. In a case where such a call has been made or in a case where a message has been sent from the browsing member to the member in need of care via the messaging control section 205, the activity detecting section 203 may judge that care has been provided by the browsing member. In a case of NO judgment in S33, the processing returns to S31. In a case of YES judgment in S33, the processing continues to S24.

In S34, the activity detecting section 203 notifies the information processing apparatus 1A of the provision, by the browsing member, of care for the member in need of care. This notification may contain the ID of the browsing member and the ID of the member in need of care. Upon reception of this notification, in the information processing apparatus 1A, YES judgment is made in S15 of FIG. 11, and the process of S16 and the subsequent processes are carried out.

In S35, the presenting section 202 judges whether to display the evaluation result. For example, in a case where the accepting section 201 accepts the operation of displaying the evaluation result, the presenting section 202 may judge that the evaluation result should be displayed. In a case of No judgment in S35, the processing of FIG. 12 ends. In a case of YES judgment in S35, the processing continues to S36.

In S36, the accepting section 201 acquires, from the information processing apparatus 1A, at least one selected from the group consisting of the evaluation result of the browsing member and the evaluation result of the group to which the browsing member belongs. Note that the accepting section 201 may acquire the evaluation result of the browsing member in a case of accepting the operation of displaying the evaluation result of the browsing member, and acquire the evaluation result of a group to which the browsing member belongs in a case of accepting the operation of displaying the evaluation result of the group.

In S37, the presenting section 202 presents the evaluation result acquired in S36 to the browsing member. As an example, the presenting section 202 may display the UI screen such as the Img 6 or 7 of FIG. 9, to present the evaluation result. As another example, the presenting section 202 may cause audio output equipment to output the evaluation result, to present the evaluation result. With the end of the process of S37, the processing of FIG. 12 ends.

### [Variation]

The performer which carried out each of the processes described in the above example embodiments is any performer, and is not limited to the above examples. That is, apparatuses which constitute the mutual watching system 3 can be changed as appropriate provided that the processes described in the above example embodiments can be carried out. For example, one or more of the functions of the information processing apparatus 1A may be implemented by another server, or one or more of the functions of the information processing apparatus 1A may be implemented by the terminal 2. In the flowcharts illustrated in FIGS. 11 and 12, the processes of the steps may be carried out by a single apparatus (interchangeable with a processor), or may be carried out respective apparatuses (similarly, interchangeable with processors). That is, the processes illustrated in FIGS. 11 and 12 may be carried out by a single processor, or may be carried out by a plurality of processors.

### [Software Implementation Example]

Some or all of the functions of each of the information processing apparatuses 1 and 1A and terminal 2 may be implemented by hardware such as an integrated circuit (IC chip), or may be implemented by software.

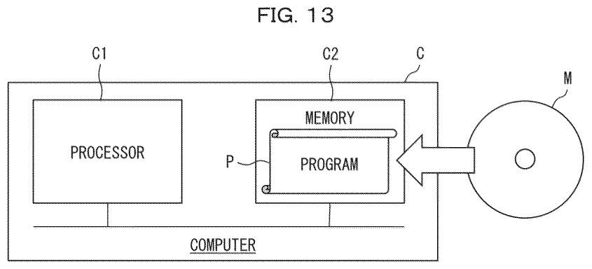

In the latter case, the information processing apparatuses 1 and 1A and the terminal 2 are provided by, for example, a computer that executes instructions of a program that is software implementing the foregoing functions. An example (hereinafter, computer C) of such a computer is illustrated in FIG. 13. FIG. 13 is a block diagram illustrating a hardware configuration of the computer C which functions as the information processing apparatuses 1 and 1A and the terminal 2.

The computer C includes at least one processor C1 and at least one memory C2. The memory C2 has recorded thereon a program P (control program) for causing the computer C to operate as the information processing apparatuses 1 and 1A and the terminal 2. The processor C1 of the computer C retrieves the program P from the memory C2 and executes the program P, so that the functions of the information processing apparatuses 1 and 1A and the terminal 2 are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### [Additional Remark A]

The whole or part of the example embodiments disclosed above can be described as, but not limited to, the following supplementary notes.

### (Supplementary Note A1)

An information processing apparatus, including: a member evaluating means for performing, based on a status of provision of care provided to a member who is inferred to be in a state of being in need of care from among members of a group and provided by one or more other members of the group, evaluations of degrees of contribution of the one or more other members to the group; and an evaluation result presenting means for presenting results of the evaluations to the members of the group.

### (Supplementary Note A2)

The information processing apparatus described in supplementary note A1, further including: a state inferring means for inferring, from an image of the member, a state of the member shown in the image; and a notifying means for notifying the one or more other members of the group of the member inferred, by the state inferring means, to be in a state of being in need of care.

### (Supplementary Note A3)

The information processing apparatus described in supplementary note A1 or A2, further including a group evaluating means for performing an evaluation of the group based on results of the evaluations of respective members belonging to the group performed by the member evaluating means.

### (Supplementary Note A4)

The information processing apparatus described in supplementary note A3, in which the group evaluating means is configured to use an index value which indicates equality among the degrees of contribution of the respective members, to perform the evaluation of the group.

### (Supplementary Note A5)

The information processing apparatus described in supplementary note A3 or A4, further including a reward giving means for giving rewards to a predetermined number of groups ranked high on a result of the evaluation performed by the group evaluating means, from among a plurality of groups subjected to the evaluation.

### (Supplementary Note A6)

The information processing apparatus described in any one of supplementary notes A1 to A5, further including: a message presenting means for presenting to the members a message generated with use of a language model trained by machine learning; and a training means for retraining the language model with use of a message from among messages presented by the message presenting means, the message resulting in, after the messages are presented to the members, an improvement in the results of the evaluations of the members performed by the member evaluating means.

### (Supplementary Note A7)

The information processing apparatus described in any one of supplementary notes A1 to A6, further including a reward giving means for giving rewards in accordance with the results of the evaluations performed by the member evaluating means, to the members who are subjected to the evaluations by the member evaluating means.

### [Additional Remark B]

### (Supplementary Note B1)

A mutual watching method, including: at least one processor carrying out a member evaluating process of performing, based on a status of provision of care provided to a member who is inferred to be in a state of being in need of care from among members of a group and provided by one or more other members of the group, evaluations of degrees of contribution of the one or more other members to the group; and the at least one processor carrying out an evaluation result presenting process of presenting results of the evaluations to the members of the group.

### (Supplementary Note B2)

The mutual watching method described in supplementary note B1, further including: the at least one processor carrying out a state inferring process of inferring, from an image of the member, a state of the member shown in the image; and the at least one processor carrying out a notifying process of notifying the one or more other members of the group of the member inferred, in the state inferring process, to be in a state of being in need of care.

### (Supplementary Note B3)

The mutual watching method described in supplementary note B1 or B2, further including the at least one processor carrying out a group evaluating process of performing an evaluation of the group based on results of the evaluations of respective members belonging to the group performed in the member evaluating process.

### (Supplementary Note B4)

The mutual watching method described in supplementary note B3, in which in the group evaluating process, the at least one processor uses an index value which indicates equality among the degrees of contribution of the respective members, to perform the evaluation of the group.

### (Supplementary Note B5)

The mutual watching method describes in supplementary note B3 or B4, further including the at least one processor carrying out a reward giving process of giving rewards to a predetermined number of groups ranked high on a result of the evaluation performed in the group evaluating process, from among a plurality of groups subjected to the evaluation.

### (Supplementary Note B6)

The mutual watching method described in any one of supplementary notes B1 to B5, further including the at least one processor carrying out a message presenting process of presenting to the members a message generated with use of a language model trained by machine learning; and the at least one processor carrying out a training process of retraining the language model with use of a message from among messages presented in the message presenting process, the message resulting in, after the messages are presented to the members, an improvement in the results of the evaluations of the members performed in the member evaluating process.

### (Supplementary Note B7)

The mutual watching method described in any one of supplementary notes B1 to B6, further including the at least one processor carrying out a reward giving process of giving rewards in accordance with the results of the evaluations performed in the member evaluating process, to the members who are subjected to the evaluations in the member evaluating process.

### [Additional Remark C]

### (Supplementary Note C1)

A control program for causing a computer to function as: a member evaluating means for performing, based on a status of provision of care provided to a member who is inferred to be in a state of being in need of care from among members of a group and provided by one or more other members of the group, evaluations of degrees of contribution of the one or more other members to the group; and an evaluation result presenting means for presenting results of the evaluations to the members of the group.

### (Supplementary Note C2)

The control program described in supplementary note C1, further causing the computer to function as: a state inferring means for inferring, from an image of the member, a state of the member shown in the image; and a notifying means for notifying the one or more other members of the group of the member inferred, by the state inferring means, to be in a state of being in need of care.

### (Supplementary Note C3)

The control program described in supplementary note C1 or C2, further causing the computer to function as a group evaluating means for performing an evaluation of the group based on results of the evaluations of respective members belonging to the group performed by the member evaluating means.

### (Supplementary Note C4)

The control program described in supplementary note C3, in which the group evaluating means is configured to use an index value which indicates equality among the degrees of contribution of the respective members, to perform the evaluation of the group.

### (Supplementary Note C5)

The control program described in supplementary note C3 or C4, further causing the computer to function as a reward giving means for giving rewards to a predetermined number of groups ranked high on a result of the evaluation performed by the group evaluating means, from among a plurality of groups subjected to the evaluation.

### (Supplementary Note C6)

The control program described in any one of supplementary notes C1 to C5, further causing the computer to function as: a message presenting means for presenting to the members a message generated with use of a language model trained by machine learning; and a training means for retraining the language model with use of a message from among messages presented by the message presenting means, the message resulting in, after the messages are presented to the members, an improvement in the results of the evaluations of the members performed by the member evaluating means.

### (Supplementary Note C7)

The control program described in any one of supplementary notes C1 to C6, further causing the computer to function as a reward giving means for giving rewards in accordance with the results of the evaluations performed by the member evaluating means, to the members who are subjected to the evaluations by the member evaluating means.

### [Additional Remark D]

### (Supplementary Note D1)

An information processing apparatus, including at least one processor, the at least one processor carrying out: a member evaluating process of performing, based on a status of provision of care provided to a member who is inferred to be in a state of being in need of care from among members of a group and provided by one or more other members of the group, evaluations of degrees of contribution of the one or more other members to the group; and an evaluation result presenting process of presenting results of the evaluations to the members of the group.

### (Supplementary Note D2)

The information processing apparatus described in supplementary note D1, in which the at least one processor further carries out: a state inferring process of inferring, from an image of the member, a state of the member shown in the image; and a notifying process of notifying the one or more other members of the group of the member inferred, in the state inferring process, to be in a state of being in need of care.

### (Supplementary Note D3)

The information processing apparatus described in supplementary note D1 or D2, in which the at least one processor further carries out a group evaluating process of performing an evaluation of the group based on results of the evaluations of respective members belonging to the group performed in the member evaluating process.

### (Supplementary Note D4)

The information processing apparatus described in supplementary note D3, in which in the group evaluating process, the at least one processor uses an index value which indicates equality among the degrees of contribution of the respective members, to perform the evaluation of the group.

### (Supplementary Note D5)

The information processing apparatus described in supplementary note D3 or D4, in which the at least one processor further carries out a reward giving process of giving rewards to a predetermined number of groups ranked high on a result of the evaluation performed in the group evaluating process, from among a plurality of groups subjected to the evaluation.

### (Supplementary Note D6)

The information processing apparatus described in any one of supplementary notes D1 to D5, in which the at least one processor further carries out: a message presenting process of presenting to the members a message generated with use of a language model trained by machine learning; and a training process of retraining the language model with use of a message from among messages presented in the message presenting process, the message resulting in, after the messages are presented to the members, an improvement in the results of the evaluations of the members performed in the member evaluating process.

### (Supplementary Note D7)

The information processing apparatus described in any one of supplementary notes D1 to D6, in which the at least one processor further carries out a reward giving process of giving rewards in accordance with the results of the evaluations performed in the member evaluating process, to the members who are subjected to the evaluations in the member evaluating process.

### [Additional Remark E]

The information processing apparatus may further include a memory. The memory may have stored therein a control program for causing the at least one processor to carry out each of the above processes.

### (Supplementary Note E1)

A non-transitory recording medium having recorded thereon a control program for causing a computer to function as an information processing apparatus, the control program causing the computer to carry out: a member evaluating process of performing, based on a status of provision of care provided to a member who is inferred to be in a state of being in need of care from among members of a group and provided by one or more other members of the group, evaluations of degrees of contribution of the one or more other members to the group; and an evaluation result presenting process of presenting results of the evaluations to the members of the group.

### REFERENCE SIGNS LIST

1: Information processing apparatus
101: Member evaluating section (member evaluating means)
102: Evaluation result presenting section (evaluation result presenting means)
1A: Information processing apparatus
101A: Member evaluating section (member evaluating means)
102A: Evaluation result presenting section (evaluation result presenting means)
104A: State inferring section (state inferring means)
105A: Notifying section (notifying means)
107A: Reward giving section (reward giving means)
108A: Group evaluating section (group evaluating means)
109A: Message presenting section (message presenting means)
110A: Training section (training means)
112A: Language model
2: Terminal
3: Mutual watching system

1. An information processing apparatus, comprising
at least one processor, the at least one processor carrying out:
a member evaluating process of performing, based on a status of provision of care provided to a member who is inferred to be in a state of being in need of care from among members of a group and provided by one or more other members of the group, evaluations of degrees of contribution of the one or more other members to the group; and
an evaluation result presenting process of presenting results of the evaluations to the members of the group.

2. The information processing apparatus according to claim 1, wherein
the at least one processor further carries out:
a state inferring process of inferring, from an image of the member, a state of the member shown in the image; and
a notifying process of notifying the one or more other members of the group of the member inferred, in the state inferring process, to be in a state of being in need of care.

3. The information processing apparatus according to claim 1, wherein
the at least one processor further carries out a group evaluating process of performing an evaluation of the group based on results of the evaluations of respective members belonging to the group performed in the member evaluating process.

4. The information processing apparatus according to claim 3, wherein
in the group evaluating process, the at least one processor uses an index value which indicates equality among the degrees of contribution of the respective members, to perform the evaluation of the group.

5. The information processing apparatus according to claim 3, wherein
the at least one processor further carries out a reward giving process of giving rewards to a predetermined number of groups ranked high on a result of the evaluation performed in the group evaluating process, from among a plurality of groups subjected to the evaluation.

6. The information processing apparatus according to claim 1, wherein
the at least one processor further carries out:
a message presenting process of presenting to the members a message generated with use of a language model trained by machine learning; and
a training process of retraining the language model with use of a message from among messages presented in the message presenting process, the message resulting in, after the messages are presented to the members, an improvement in the results of the evaluations of the members performed in the member evaluating process.

7. The information processing apparatus according to claim 1, wherein
the at least one processor further carries out a reward giving process of giving rewards in accordance with the results of the evaluations performed in the member evaluating process, to the members who are subjected to the evaluations in the member evaluating process.

8. A mutual watching method, comprising:
at least one processor performing, based on a status of provision of care provided to a member who is inferred to be in a state of being in need of care from among members of a group and provided by one or more other members of the group, evaluations of degrees of contribution of the one or more other members to the group; and
the at least one processor presenting results of the evaluations to the members of the group.

9. A computer-readable non-transitory recording medium having recorded thereon a control program for causing a computer to carry out:
a member evaluating process of performing, based on a status of provision of care provided to a member who is inferred to be in a state of being in need of care from among members of a group and provided by one or more other members of the group, evaluations of degrees of contribution of the one or more other members to the group; and
an evaluation result presenting process of presenting results of the evaluations to the members of the group.

10. A mutual watching system, comprising:
the information processing apparatus according to claim 1; and
a terminal for presenting the results of the evaluations to a member who uses the terminal.
